(19) United States
(12) Patent Application Publication
(10) Pub. No.: US 2025/0180084 A1
(43) Pub. Date: Jun. 5, 2025

(54) BRAKE DEVICE FOR A MOTOR VEHICLE

(71) Applicant: Continental Automotive Technologies GmbH, Hannover (DE)

(72) Inventors: Martin Gädke Gädke, Hofheim (DE); Jens Hoffmann, Darmstadt (DE); Christian Vey, Petersberg (DE); Ahmed Sefo, Frankfurt am Main (DE); Falk Petzold, Frankfurt am Main (DE); Adrian Messner, Mainz (DE); Matthias Schulitz, Frankfurt am Main (DE)

(73) Assignee: Continental Automotive Technologies GmbH, Hannover (DE)

(21) Appl. No.: 18/845,883

(22) PCT Filed: Mar. 10, 2023
(86) PCT No.: PCT/DE2023/200054

§ 371 Date: Sep. 11, 2024

(30) Foreign Application Priority Data
Mar. 11, 2022 (DE) 10 2022 202 445.1

(51) Int. Cl. F16D 65/22; F16D 51/20; F16D 121/24; F16D 125/40; F16D 125/48; F16D 127/06

(52) U.S. Cl. CPC F16D 65/22; F16D 51/20; F16D 2121/24; F16D 2125/40; F16D 2125/48; F16D 2127/06

(57) ABSTRACT

A brake device for a motor vehicle has an expansion unit which is designed to, proceeding from a neutral position, in the one driving direction generate a service brake, and in the other driving direction generate a self-locking of a function of a parking brake. For this purpose, the expansion unit has a nut/spindle unit which optionally interacts with an axial bearing or a friction-fitting coupling unit.

### TECHNICAL FIELD

A brake device for a motor vehicle has a brake member for generating a friction-fit with a rotating component.

### BACKGROUND

Brake devices are used in drum brakes working according to the simplex, duplex, duo duplex or the like principle, and in floating calipers and are known from practice. However, in addition to the function of a service brake, motor vehicles also require the function of a parking brake. In the function of the service brake, the expansion unit is to generate the friction-fit between the brake member and the rotating component as quickly as possible when the actuator is energized, and to release the friction-fit again as quickly as possible when the actuator is de-energized. In the function of the parking brake, however, the friction-fit should be maintained even when the actuator is de-energized. Therefore, two actuators with respective expansion units are mostly used for each function. However, this makes the brake device complex in terms of construction.

### SUMMARY

The embodiments are based on the object of refining a brake device in such a way that it is simple in terms of construction and enables the function of the service brake and the parking brake.

This object is achieved in that the expansion unit is designed to, proceeding from a neutral position, in the one driving direction of the actuator generate a service brake, and in the other driving direction of the actuator generate a self-locking of a function of a parking brake.

This design uses different driving directions in order to generate either a smooth-running service brake with a self-release mechanism, or a self-locking mechanism for the function of a parking brake, in the respective end position of the driving direction. The self-locking mechanism can generate a force-fit or a form-fit between the components supporting the braking forces. Thanks to the invention, only a single actuator with a single expansion unit is required for both functions of the brake device. The brake device is of a particularly simple construction as a result.

According to another advantageous refinement of the invention, the generation of different functions of the brake device is particularly simple in terms of construction when a driven nut/spindle unit having a nut screwed onto a spindle in the one driving direction of the actuator by way of an axial bearing is supported on a first non-rotatable expansion thrust piece, and in the other driving direction of the actuator by way of a force-fitting or form-fitting coupling unit is supported on a second non-rotatable expansion thrust piece. This design allows the driven nut/spindle unit with the two non-rotatable thrust pieces to be operatively connected selectively to either the axial bearing or the coupling unit. If the nut/spindle unit is supported by the axial bearing, a particularly smooth transmission of force between the nut/spindle unit and the expansion thrust pieces is made possible.

For further simplification of the structure of the brake device, it contributes according to another advantageous development of the invention, when one of the components of the spindle or the nut can be moved optionally against the axial bearing or against the coupling unit as a function of the driving direction. This design allows the force flux in the one function of the service brake to be easily guided via the axial bearing and in the other function of the parking brake via the coupling unit.

For example, the nut/spindle unit could be axially guided in a housing. However, the brake device according to another advantageous refinement of the invention is of a particularly compact design when the expansion thrust pieces are connected to a component of the nut/spindle unit so as to be axially displaceable and non-rotatable. The brake device is of a particularly compact design as a result.

According to another advantageous refinement of the invention, the brake member in the function of the parking brake can be held in its position without further energy expenditure when the coupling unit has a friction pair disposed on the nut/spindle unit and on one of the expansion thrust pieces. As a result of this design, the coupling unit generates self-locking by a force-fit.

A large surface of the friction pair can be achieved when the friction pair is disposed between the nut and the second expansion thrust piece.

According to another refinement, the brake device is able to support high forces in the function of the parking brake when the friction pair is formed as a bevel inclined toward the rotation axis of the nut.

A uniform introduction of force into the axial bearing can be ensured according to another refinement when a supporting disk is disposed between the nut and the first expansion thrust piece.

According to another refinement, the spindle is supported selectively on the one or the other of the expansion thrust pieces as a function of the driving direction, when the spindle has support faces opposite each of the expansion thrust pieces.

The brake device can be driven to the two functions with low friction and without play when the nut/spindle unit is designed as a ball screw drive.

For further reduction of the dimensions of the brake device, it contributes according to another refinement, when the nut is rotatably mounted in a housing and has an external toothing for connecting to a driven gear wheel.

### DESCRIPTION OF THE DRAWINGS

The invention permits numerous embodiments. To further illustrate its basic principle, the embodiments are illustrated in the drawings and will be described in the following text. In the drawings:

FIG. 1 schematically shows a brake device designed as a drum brake;

FIG. 2 shows a housing with an expansion unit from FIG. 1 in a perspective view;

FIG. 3 shows the expansion unit from FIG. 2 with a cut-open housing;

FIG. 4 shows a longitudinal section through the housing and the expansion unit from FIG. 2 in a neutral position;

FIG. 5 shows the expansion unit illustrated in FIG. 4 in a service brake position; and

FIG. 6 shows the expansion unit illustrated in FIG. 4 in a parking brake position.

### DETAILED DESCRIPTION

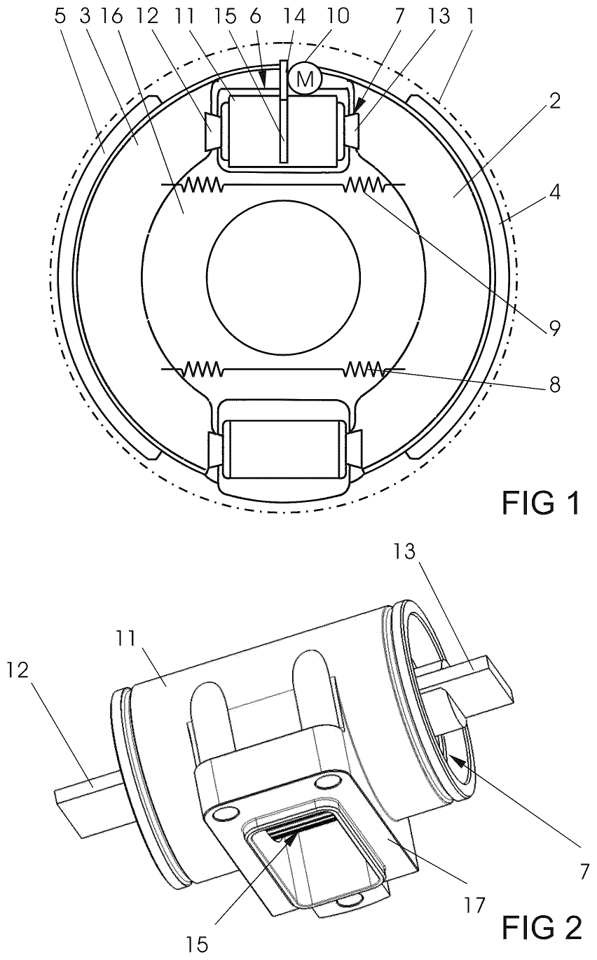

FIG. 1 schematically shows a brake device designed as a drum brake of a motor vehicle, having a rotatably mounted brake drum 1. The brake drum 1 encloses two brake members 2, 3 which are designed as brake shoes and have friction pads 4, 5. The brake shoes can be moved against the brake drum 1 by an actuator 6 with an expansion unit 7, so as to generate a frictional torque. In the exemplary embodiment illustrated, tension springs 8, 9 pretension the brake shoes in relation to the expansion unit 7 and thus enable their return movement from the brake drum 1. The actuator 6 has an electric motor 10 which can be driven in both directions of rotation, and a housing 11 with the expansion unit 7 disposed therein. Two expansion thrust pieces 12, 13 of the expansion unit 7, which support themselves on the brake shoes, protrude from the housing 11. The brake shoes secure the expansion thrust pieces 12, 13 in a non-rotatable position. A gear wheel 14 driven by the electric motor 10 penetrates into the housing 11 and drives a drive pinion 15 of the expansion unit 7 selectively in the one rotation direction or the other rotation direction. The housing 11 is mounted in a floating manner on a support plate 16 in the exemplary embodiment illustrated.

FIG. 2 shows the housing 11 of the expansion unit 7 with a mounting flange 17 for attaching to the electric motor 10 and the support plate 16 from FIG. 1, in a perspective view. The drive pinion 15 is accessible via the mounting flange 17.

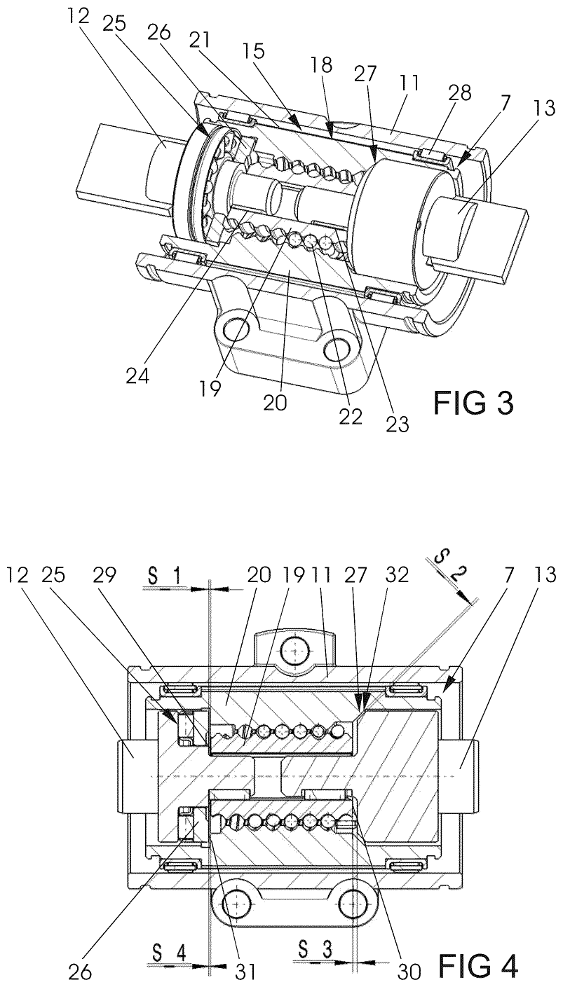

FIG. 3 shows the expansion unit 7 from FIG. 2 with a cut-open housing 11 in a perspective view. A nut/spindle unit 18 designed as a ball screw drive is disposed in the housing 11. A nut 20 screwed onto a spindle 19 is mounted in the housing 11 and supports an external toothing 21 of the drive pinion 15 on its outer surface. The spindle 19 is disposed radially within the nut 20 and connected to the latter via recirculating balls 22. The expansion thrust pieces 12, 13 are guided in a non-rotatable and axially displaceable manner on the spindle 19 via feather keys 23, 24. An axial bearing 25 having a supporting disk 26 is disposed between a first thrust piece 12 and the nut/spindle unit 18. A coupling unit 27 is disposed between a second thrust piece 13 and the nut/spindle unit 18. The axial bearing 25 enables particularly low-friction rotation of the first expansion thrust piece 12 relative to the adjacent component of the nut/spindle unit 18. In the event of contact, the coupling unit 27 generates a force-fit or form-fit in the rotation direction between the second expansion thrust piece 13 and the opposite component of the nut/spindle unit 18. The mounting of the nut 20 in the housing 11 has radial cylindrical roller bearings 28 and enables an at least limited axial displaceability of the nut/spindle unit 18 in the housing 11, so that the maximum travel of the expansion unit 7 can be covered.

FIG. 4 shows a longitudinal section through the housing 11 and the expansion unit 7 in a neutral position. This position corresponds to an operating position in which the brake members 2, 3 are removed from the brake drum 1. The neutral position FIG. 4 is de-energized when the brake device is designed as a dual servo drum brake, in which a counter bearing to the friction pads 4, 5 keeps the friction pads 4, 5 at a distance. Otherwise, this neutral position in the Si embodiment is an intermediate position in which, for example, the pad springs compress the expansion unit 7, or this position is overrun when changing from, for example, service brake to parking brake. This position is overrun when de-energized, as the brake device must be embodied so as to be open when de-energized in the case of a service brake.

Gaps of the nut/spindle unit 18 in relation to the adjacent components of the expansion thrust pieces 12, 13, the axial bearing 25 or the coupling unit 27, are denoted by S1 to S4. The spindle 19 has support faces 29, 30 opposite each of the expansion thrust pieces 12, 13. The nut 20 has a support face 31 opposite the supporting disk 26 and a friction pair 32 forming the coupling unit 27 in relation to the second expansion thrust piece 13. The friction pair 32 is designed as a bevel inclined toward the axis of rotation. It can be seen that gaps S1 to S4 of the nut/spindle unit 18 are open toward all adjacent components in the neutral position shown. If the nut 20 is driven proceeding from the position illustrated in FIG. 4, the spindle 19 is driven via the balls 22 of the nut/spindle unit 18 designed as a ball screw drive. The spindle 19 is moved axially in relation to the expansion thrust pieces 12, 13 via the feather keys 23, 24, wherein the expansion thrust pieces 12, 13 of the brake members 2, 3 from FIG. 1 are held so as to be non-rotatable.

In the one rotation direction of the nut 20, the spindle 19 by one of the support faces 30 moves against the first thrust piece 12, and the nut 20 by way of its support face 31 moves against the supporting disk 26 of the axial bearing 25, as shown in FIG. 5. The gaps S4 and S3 are thereby closed and the expansion thrust pieces 12, 13 are expanded so as to move the brake members 2, 3 shown in FIG. 1 against the brake drum 1. To illustrate this, the force flux through the expansion unit 7 is marked in the drawing as a freehand line. Since the force flux is guided through the axial bearing 25 and past the coupling unit 27, the expansion is particularly low-friction, so that the force flux is absent as soon as the electric motor 10 is de-energized. In the case of a de-energized electric motor 10, the expansion unit 7 moves independently into the neutral position shown in FIG. 4 due to the force of the tension springs 8, 9 shown in FIG. 1, and thus generates a self-release of the brake device. Thus, the position of the actuator 6 shown in FIG. 5 indicates the function of a service brake of the brake device.

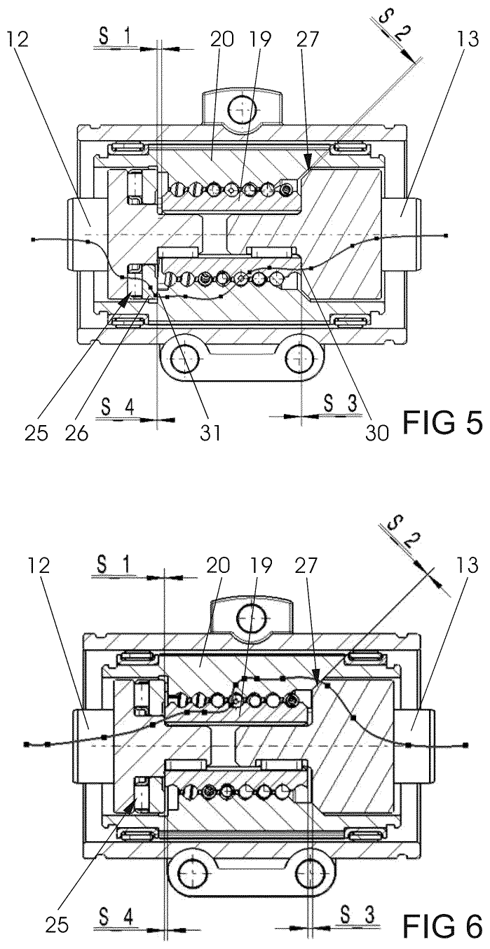

If, proceeding from the position from FIG. 4, the nut 20 is driven in the other rotation direction, the nut 20 reaches the coupling unit 19 and thus moves against the first expansion thrust piece 12, as shown in FIG. 6. The spindle 19 is supported by one of its support faces 29 on the first expansion thrust piece 13. Thereby, the gaps S1 and S2 are closed and a force flux marked in the drawing can be transmitted through the expansion thrust pieces 12, 13 and the nut/spindle unit 18. The force flux passes through the coupling unit 27 and past the axial bearing 25 and is marked in FIG. 6 as a freehand line. Due to the coupling unit 27 however, self-locking is generated by friction of the friction pair 32, which holds the components in the position shown, even when the electric motor 10 is de-energized. In order to move the expansion unit 7 from the position shown in FIG. 6 back to the neutral position shown in FIG. 4, said expansion unit 7 must be actively driven by the electric motor 10 in order to release the frictional torque of the friction pair 32 of the coupling unit 27. FIG. 6 thus indicates the function of a parking brake of the brake device. Due to the shown guidance of the force flux through the components disposed within the housing 11, the external toothing 21 and the drive pinion 15 are not loaded with holding forces in the function of the parking brake.

In an embodiment not shown, the expansion unit 7 may have an axial bearing at the gap marked with S3. Furthermore, the expansion unit 7 may have a coupling unit at the gap marked with S1 in an embodiment not shown.

1. A brake device for a motor vehicle comprising:
a brake member for generating a friction-fit with a rotating component;
an actuator which can be driven in two directions of movement and moves the brake member relative to the rotating component;
an expansion unit of the actuator, wherein from a neutral position the expansion unit, in the one driving direction of the actuator generates a service brake by driving the actuator in one direction of movement, and generates a self-locking function of a parking brake by driving the actuator in the other direction of movement.

2. The brake device as claimed in claim 1, wherein a spindle unit has a nut screwed onto a spindle in the one driving direction of the actuator by way of an axial bearing is supported on a first non-rotatable expansion thrust piece, and in the other driving direction of the actuator by way of a force-fitting or form-fitting coupling unit is supported on a second non-rotatable expansion thrust piece.

3. The brake device as claimed in claim 2, wherein one of the components of the spindle or the nut can be moved optionally against the axial bearing or against the coupling unit as a function of the driving direction.

4. The brake device as claimed in claim 2, wherein the expansion thrust pieces are connected to a component of the spindle unit so as to be axially displaceable and non-rotatable.

5. The brake device as claimed in claim 2, wherein the coupling unit has a friction pair disposed on the spindle unit and on one of the expansion thrust pieces.

6. The brake device as claimed in claim 5, wherein the friction pair is disposed between the nut and the second expansion thrust piece.

7. The brake device as claimed in claim 5, wherein the friction pair is formed as a bevel inclined toward the rotation axis of the nut.

8. The brake device as claimed claim 2, wherein a supporting disk is disposed between the nut and the first expansion thrust piece.

9. The brake device as claimed in claim 2, wherein the spindle has support faces opposite each of the expansion thrust pieces.

10. The brake device as claimed in claim 2, wherein the spindle unit is a ball screw drive.

11. The brake device as claimed in claim 2, wherein the nut is rotatably mounted in a housing and has an external toothing for connecting to a driven gear wheel.
